(19) United States
(12) Patent Application Publication
(10) Pub. No.: US 2019/0180395 A1
(43) Pub. Date: Jun. 13, 2019

(54) ASSISTANCE ENGINE FOR MULTIPARTY MEDIATION

(71) Applicant: FairClaims, Inc., Los Angeles, CA (US)

(72) Inventors: Matt Moretti, Beverly Hills, CA (US); John Boese, Los Angeles, CA (US)

(21) Appl. No.: 16/213,961

(22) Filed: Dec. 7, 2018

Related U.S. Application Data
(60) Provisional application No. 62/596,483, filed on Dec. 8, 2017.

(51) Int. Cl. G06Q 50/18; G06N 20/00

(52) U.S. Cl. CPC G06Q 50/182; G06N 20/00

(57) ABSTRACT

The subject disclosure relates to methods for facilitating a settlement between two or more parties engaged in mediation through an online platform. In some aspects, the disclosed technology provides settlement suggestions and predictions based on historic settlement data. Settlement suggestions and predictions can be informed using a machine learning (ML) model that is configured to make predictions about the likelihood of acceptance of various settlement amounts by all mediating parties. In some aspects, ML model may also provide messages to one or more parties engaged in mediation to encourage settlement. Systems and computer-readable media are also provided.

### CROSS-REFERENCE TO RELATED APPLICATIONS

This application claims the benefit of U.S. Application No. 62/596,483, filed Dec. 8, 2017, entitled “AI Engine for Multiparty Settlement”, which is incorporated by reference in its entirety.

### BACKGROUND

### 1. Technical Field

The disclosed technology relates to systems and methods for implementing an online mediation platform and in particular, for facilitating dispute resolution between adverse parties using suggestions generated using various machine learning (ML) models, and artificial intelligence (AI) chat bots.

### 2. Introduction

Legal mediation is a method of alternative dispute resolution often preferred by parties that wish to negotiate a legally binding settlement while avoiding the attendant costs typical of litigation. Mediation is typically facilitated by a live mediator whose primary role is to act as a neutral third-party that facilitates communication between disputants, analyzes issues, and engages in reality-testing. To this end, mediators use a wide variety of techniques to guide the negotiation process in a constructive direction, with the goal of helping disputants to focus on the issues, avoid personal attacks, and to ultimately find their optimal settlement solution.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example network environment in which an online mediation platform of the disclosed technology can be implemented.

FIG. 2 illustrates a conceptual block diagram of an online mediation platform that implements a settlement-prediction machine-learning (ML) model, according to some aspects of the disclosed technology.

FIG. 3 illustrates steps of an example process for calculating settlement predictions and for generating settlement suggestions, according to some aspects of the disclosed technology.

FIG. 4 illustrates an example of graphical user interface (GUI) display that can be provided to a user to convey information generated by a settlement-prediction ML model, according to some aspects of the technology.

FIG. 5 illustrates an example GUI that can be provided to a user to convey information generated by a settlement-facilitation ML model (AI chat bot), according to some aspects of the technology.

FIG. 6 illustrates an example of an electronic system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview:

Although conventional (human-assisted) mediation can be more expeditious and cost efficient than litigation, limitations on mediator time and knowledge ultimately constrain mediation throughput and quality. Aspects of the disclosed technology address the foregoing limitations of conventional human-mediator based dispute resolution by providing a virtual mediation platform that utilizes machine-learning (ML) models to facilitate settlement negotiations between disputants. As discussed in further detail below, ML models can be used to provide data-driven settlement predictions based on attributes of historic settlements, i.e., settlement data. Settlement data can include virtually any information relating to previously resolved disputes that can be used to infer the acceptance likelihood of various settlement amounts. As used herein, settlement data can include but is not limited to: settlement (dollar) amounts, dispute location, dispute type, etc. Settlement predictions can also be based on inferences made about party sentiments, for example, based on an analysis of disputants' communications and/or messages, for example that can be transmitted through the mediation platform.

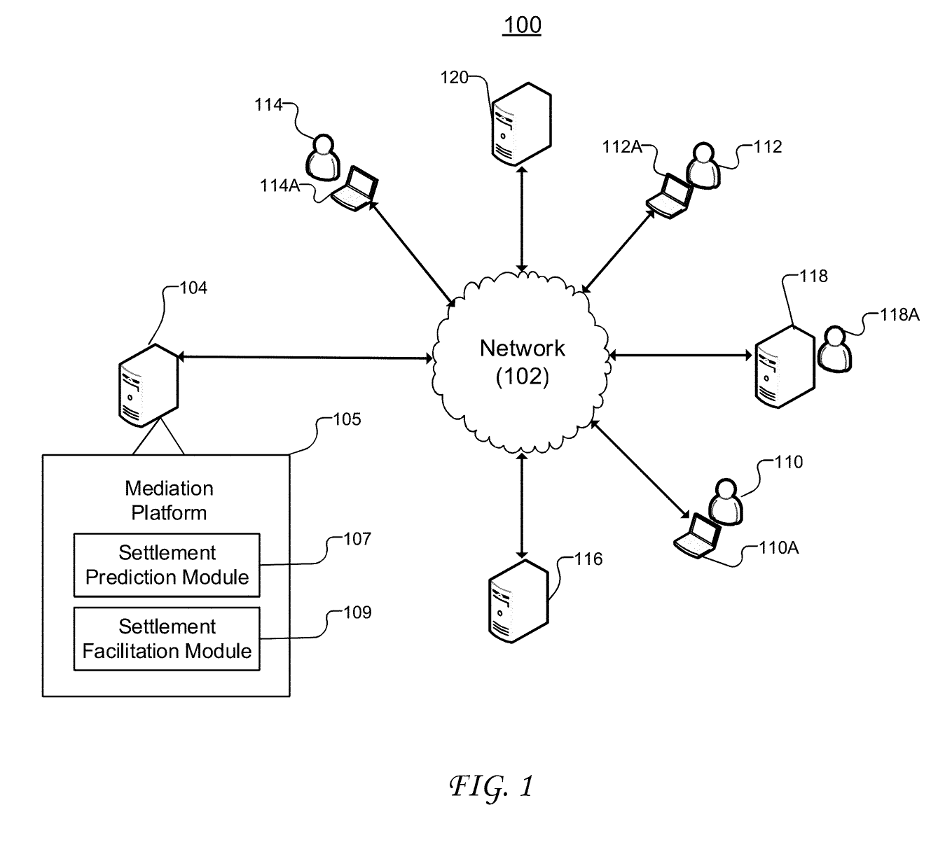

Machine learning modules can also be used to facilitate communication between disputants. For example, AI based chat bots can be used to automatically moderate communications between the parties, and in some instances to automate communications directed at specific (or all) parties to encourage settlement. By way of example, artificial intelligence (AI) based chat bots can recommend settlement amounts, remind disputants of impending settlement deadlines, and make recommendations to improve communication between parties. A more detailed description of the various embodiments of the disclosed technology is provided in context of FIGS. 1-5, discussed below.

By using ML models and AI based chat bots, the disclosed technology mitigates the possibility of human bias (implicit or otherwise), by providing an impartial platform for dispensing settlement suggestions, and increasing dispute mediation volume. Importantly, a goal of the disclosed technology is to deliver blind justice by providing wide availability to unprejudiced and cost effective mediation services.

### DESCRIPTION

In some aspects, the disclosed technology encompasses a computer-implemented method for facilitating dispute resolution. The method can include steps for: receiving first dispute information associated with a first user, wherein the first dispute information comprises first demographic information for the first user, receiving second dispute information associated with a second user, wherein the second dispute information comprises second demographic information for the second user, identifying an amount in controversy from the first dispute information and the second dispute information, and predicting an optimal settlement amount based on the first dispute information, the second dispute information, and/or the amount in controversy.

In some implementations, predicting an optimal settlement amount can further include providing at least one of: the first dispute information, the second dispute information and/or the amount in controversy, to a settlement-prediction ML model, and receiving the optimal settlement amount from the ML model, wherein the optimal settlement amount corresponds with a value that is most likely to be accepted by the disputants.

In some aspects, a computer-implemented method of the disclosed technology can also include steps for: generating one or more settlement suggestions based on the optimal settlement amount, wherein each of the settlement suggestions is associated with a predicted likelihood of acceptance, and automatically providing the one or more settlement suggestions to the first user and the second user.

In some aspects, the first dispute information and the second dispute information comprises a dispute location indicating a geographic region and/or legal jurisdiction associated with a dispute between the first user and the second user. The first dispute information and the second dispute information can also include a dispute type indicating a type of dispute between the disputants, i.e., the first user and the second user.

In some aspects, a computer-implemented method of the disclosed technology can further include steps for: receiving a message from the first user, wherein the message comprises a text input provided by the first user, analyzing the message from the first user to determine a sentiment associated with the first user, and wherein predicting the optimal settlement amount is further based on the sentiment associated with the first user.

FIG. 1 illustrates an example of network environment 100 in which some aspects of the technology can be implemented. Environment 100 includes computer network 102 that can include one or more private networks, such as, a local area network (LAN), a wide area network (WAN), or a network of public/private networks, such as the Internet.

Network 102 is communicatively coupled to mediation system 104 that includes mediation platform 105. Mediation platform 105 includes settlement prediction module 107, and settlement facilitation module 109. Although mediation system 104 is represented by a single device, is understood that mediation system 104 can include multiple computing devices, for example, that are clustered in a similar location, or geographically distributed. For example, mediation system 104 can be implemented by a computing cluster in a cloud computing environment. Mediation platform 105, settlement prediction module 107, and/or settlement facilitation module 109 can be implemented using a variety of hardware and/or software services, such as one or more virtual machines (VMs), and/or network containers. Additionally, it is understood that mediation platform 105 can include additional software and/or hardware modules without departing from the scope of the disclosure.

Mediation platform 105 is coupled to a variety of user devices 110A, 112A, and 114A, via network 102, for example, to facilitate communication with respective users 110, 112, and 114. Mediation platform 105 is also coupled to a variety of third-party devices (116, 118, 120). As such, mediation platform 105 is configured to transact data with any and all entities in environment 100. It is understood that additional third-party resources, user devices, and users can participate in environment 100, without departing from the scope of the technology.

As discussed in further detail below, third-party devices (116, 118, 120) can include various databases and/or services that provide data used by the settlement prediction module and/or settlement facilitation module to facilitate dispute resolution between disputants. In some instances, third-party computing resources (116, 118, 120) represent service providers that utilize mediation platform 105 to arbitrate disputes with their own customers. Third-party computing resources (116, 118, 120) can also represent public or private databases that provide information regarding resolutions of previous disputes (dispute information) and/or user demographic information that can be used by settlement prediction module 107 to make predictions about the likelihood that a dispute can be settled for a particular amount.

As used herein, dispute information can include any data or information relating to previously settled disputes, as well as information pertaining to an open/ongoing dispute currently being resolved on mediation platform 105. By way of example, dispute information can include, but is not limited to, one or more of: a dispute amount, a location where the dispute occurred (e.g., state/city/town, etc.), a website where the dispute originated (i.e., a partner company name), a date and time the dispute occurred, underlying facts about the dispute, indicators of dispute categorization (e.g., auto insurance, home renovation, etc.), a subcategory of dispute (e.g., property damage, incomplete work, etc.), an indication of primary legal issues (e.g., breach of contract, negligent work, etc.). Dispute information can also include evidence, or metadata describing submitted or requested evidence, such as a number of evidence items submitted, types of evidence submitted, etc. Additionally, dispute information can include data regarding ongoing negotiations, such as a number of offers submitted by each user/party to the dispute, amounts of offers submitted, a frequency of offers submitted, a number of messages sent, a frequency of messages sent, etc.

Demographic information can include any data relating to the disputants (users). As used herein, demographic information can also include psychographic data, such as qualitative measures of users' psychological attributes. By way of example, psychographic data can include virtually any information describing a user's personality traits, such as: values, opinions, attitudes, and/or behaviors, etc. As such, user demographic data can contain psychographic profiles, such as activity, interest, opinion metrics (AIOs), etc. In some instances, psychographic data can include measures of perceptions, such as a users' confidence in their legal position, users' perceived likelihood of outcomes (decision amounts), users' perceived value in settling quickly, and/or a user's perceived value in feeling like he/she “won,” etc.

To facilitate dispute resolution between two or more parties, such as users 110, 112, and/or 114, mediation platform 105 can receive dispute information, including demographic information (including psychographic data) relating to the controversy, legal issues, and parties to the dispute. Dispute information, including the demographic information, is the provided to a machine-learning (ML) model, such as a settlement prediction ML model (i.e., settlement prediction model) that is configured to make predictions about the likelihood of different settlement amounts being accepted by the users. By way of example, settlement prediction module 107 can include an ML settlement-prediction model that has been trained using training data from previous disputes, including demographic information about previous disputants. In this manner, the ML model can offer unbiased and empirical settlement recommendations to the users. Moreover, as new settlements are reached on mediation platform 105, the ML model can be updated based on the dispute information and demographic information for the newly resolved disputes. As such, the ML model can improve over time, offering increasingly accurate settlement predictions based on unique dispositions of the disputants.

As discussed further detail below, other ML implementations can be used to facilitate negotiation discussions that occur between users on mediation platform 105. For example, settlement facilitation module 109 can be configured to implement an artificial intelligence (AI) based chat bot, for example, that can automatically generate and send communications to one or more of the parties, for example, to encourage progress towards a dispute resolution goal, such as agreement on a settlement offer.

Although it is understood that the described techniques can be implemented using a variety of machine learning and/or classification algorithms, the scope of the technology is not limited to a specific machine learning implementation. Implementations of the technology can include the deployment of multi-layered ML models based on one or more classification algorithms, including but not limited to: a Multinomial Naive Bayes classifier, a Bernoulli Naive Bayes classifier, a Perceptron classifier, a Stochastic Gradient Descent (SGD) Classifier, and/or a Passive Aggressive Classifier, or the like.

Machine learning models can be configured to perform various types of regression, for example, using one or more regression algorithms, including but not limited to: Deep Learning, a Stochastic Gradient Descent Regressor, and/or a Passive Aggressive Regressor, etc. ML models can also be based on clustering algorithms (e.g., a Mini-batch K-means clustering algorithm), a recommendation algorithm (e.g., a Miniwise Hashing algorithm, or Euclidean LSH algorithm), and/or an anomaly detection algorithm, such as a Local outlier factor. Additionally, ML models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

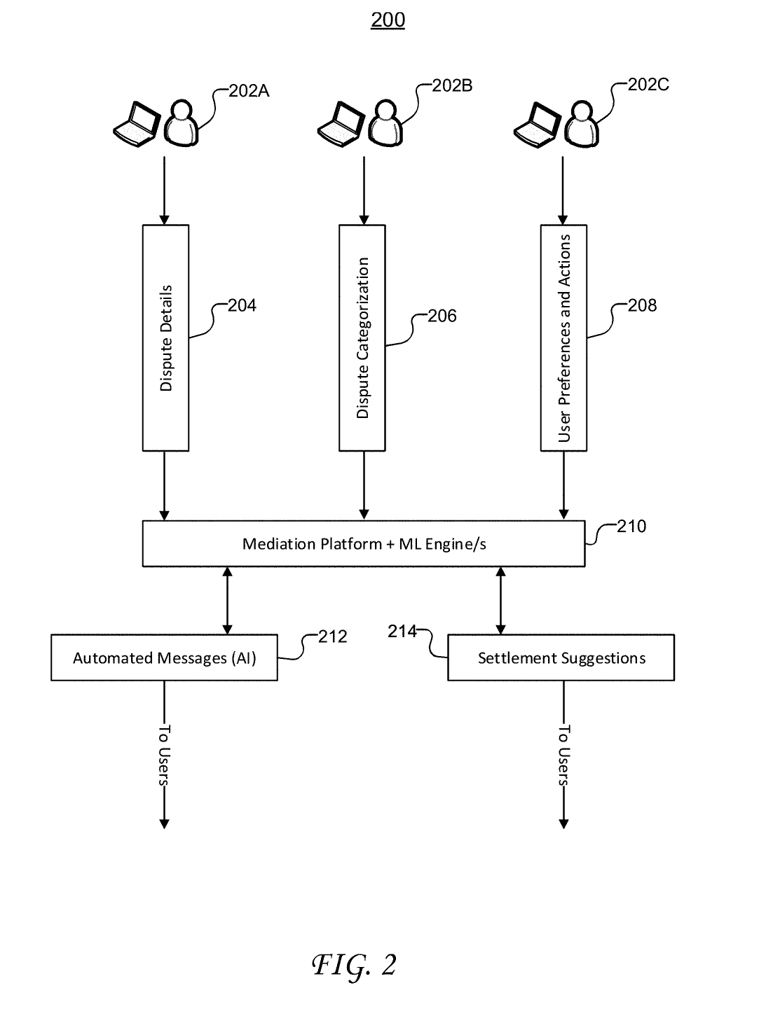

The disclosure now turns to FIG. 2, which illustrates a schematic block diagram 200 of an example communication flow through a mediation platform of the disclosed technology. Diagram 200 includes a variety of users and/or third-party representatives 202 that provide dispute information to mediation platform 210. Users 200 can include disputants or third-party representatives that provide information to mediation platform 210, for example, relating to an ongoing dispute by two or more users. By way of example, user 202B and user 202C could be involved in a dispute that occurred in relation to the use of a third-party platform associated with representative 202A, as such, information relating to the dispute can be received by all three parties.

As illustrated, information ingested by mediation platform 210 may fall into one of three broad categories, including dispute details 204, dispute categorization 206, and user preferences and actions 208. Dispute details 204 can include basic information about the dispute including, but not limited to: a dollar amount of the dispute, location information regarding where the dispute occurred, a time and/or date when the dispute occurred, and the basic underlying facts of the dispute, e.g., information related to any written contracts, etc. Dispute categorization information 206 can include information pertaining to the type of dispute at issue, including but not limited to: broadly defined dispute categories (e.g., “auto insurance,” “home renovation,” etc.), a subcategory of dispute (e.g., “property damage,” “incomplete work,” etc.), and/or primary legal issues at the center of the dispute (e.g., “breach of contract,” “negligent work,” etc.).

Mediation platform 210 can also receive and process user preferences and interactions 208. User preference and action information 208 can be received from a variety of users interacting with the platform and can include, for example, any submitted evidence, a number of previous settlement offers made, details regarding previous offers made, a number of messages sent via platform 210, and the sentiment of messages sent.

Different types of dispute information can be ingested into mediation platform 105, parsed, and associated with metadata tags for later storage in a database, such as a proprietary database accessible exclusively via mediation platform 210. As such, mediation platform 210 can be configured to store information about historic disputes (and resolutions), including demographic information about the parties involved.

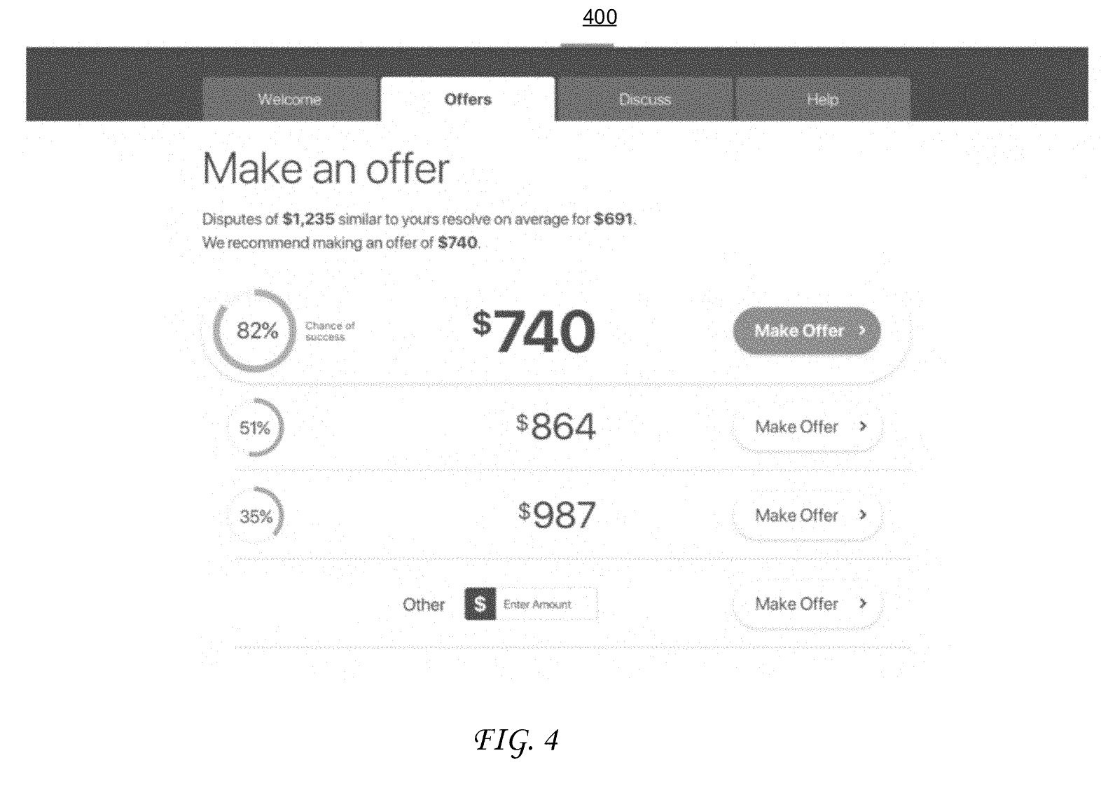

When combined, dispute details 204, dispute categorization 206, action information 208 (as well as any stored information about historic disputes and/or public data), can be provided to a machine-learning engine (e.g., an ML model) in mediation platform 210. As discussed above, ML models, such as a settlement prediction model, can use the received information to make predictions about the parties' settlement behavior. For example, the ML engine can make predictions about the likelihood that various settlement amounts will be accepted by parties in the dispute. Based on the ML engine's predictions, settlement suggestions 214 can be generated and provided to the users. An example of a settlement communication that can be generated by mediation platform 210 is discussed in further detail with respect to FIG. 4, below. User responses to settlement suggestions 214 can be fed back into the ML engine of mediation platform 210, for example, to provide ongoing (online) training to the prediction model. In this way, the ML model/s can evolve as user demographic information (including psychographic data) continues to be generated during the mediation process.

In some implementations, message sentiment can be used by an AI chat bot to facilitate the generation of customized automated messages 212 to different users, wherein the messages are calibrated to facilitate progress toward dispute resolution. In such approaches, message sentiment, determined from an analysis of user-to-user communications, can be used to determine if the users are particularly acrimonious or emotional. As such, the AI chat bot can generate automated messages 212 configured to calm the parties, encourage polite discourse, or to otherwise de-escalate potentially emotional user exchanges. Conversely, message sentiment can be used to determine if the users are amicably progressing towards a resolution, and to trigger the generation of automated messages 212, for example, that encourage quick disposal of the dispute. As illustrated, user responses to automated messages 212 can also be fed back into the ML engine of mediation platform 210 to provide ongoing (online) training to the prediction model.

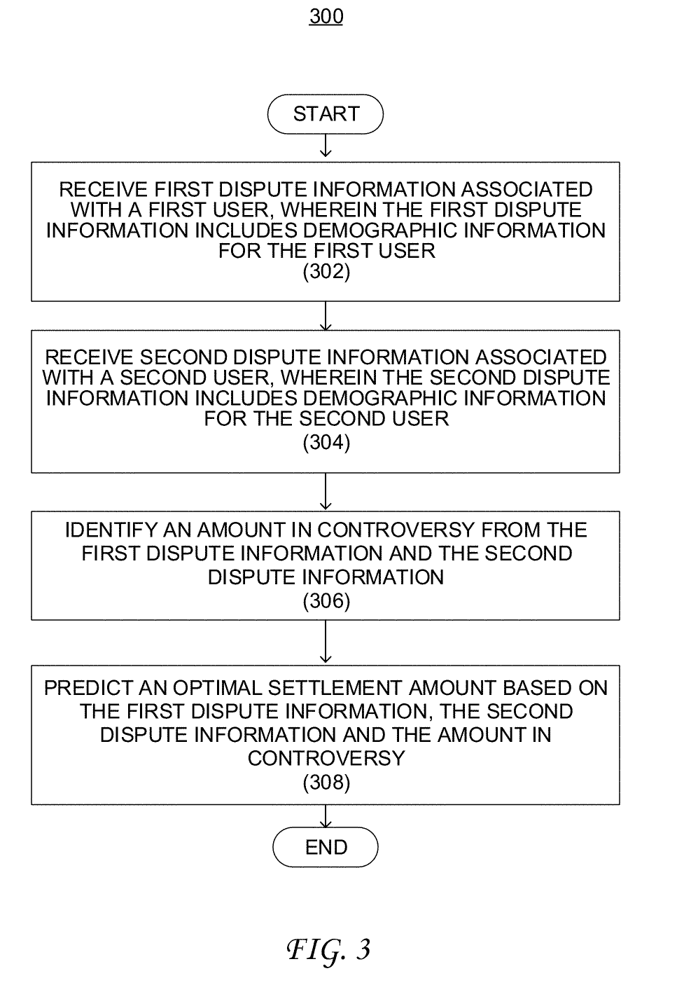

FIG. 3 illustrates steps of an example process 300 for calculating settlement predictions and for generating settlement suggestions, according to some aspects of the disclosed technology. Process 300 begins when first dispute information associated with the first user is received by mediation platform (302), such as mediation platform 210 discussed above with respect to FIG. 2. As discussed above, the first dispute information associated with the first user can include a variety of data, including demographic information pertaining to the first user.

Process 300 then proceeds to step 304 in which second dispute information associated with a second user is received by the mediation platform, wherein the second dispute information includes demographic information for the second user. Information pertaining to the dispute can also be variously received from third parties, such as third-party representatives and/or automatically ingested from third party database sources, e.g., publicly available repositories of legal settlement data, and/or proprietary data stores. By way of example, data pertaining to disputes resolved on the mediation platform can be stored to a proprietary database. Such data can then be used to perform further training on one or more settlement prediction ML models used to make predictions regarding optimal settlement amounts, and/or to inform the generation of automated messages by a chat bot on the mediation platform.

Next, an amount in controversy is identified from the first dispute information and the second dispute information (306). As discussed above, the amount in controversy can be identified by either the first user, or the second user, for example, as part of the dispute detail information provided to the mediation platform. Alternatively, the amount in controversy can be provided by a third-party representative, such as a representative of a third-party service that refers disputes to the mediation platform provided by a virtual mediation service.

Next, an optimal settlement amount is predicted based on the first dispute information, the second dispute information, and the amount in controversy (308). Prediction of the optimal settlement amount can be performed by a ML model, such as a settlement prediction model, discussed above. In some aspects, the optimal settlement amount is a quantified value that is predicted to have a highest likelihood of acceptance by all parties to the dispute. As such, the optimal settlement amount can be expressed as a dollar amount (e.g. US dollars); however, the optimal settlement amount may be quantified using any other currency, or any other metric of economic value, without departing from the scope of the disclosed technology.

In some implementations, the optimal settlement amount is a prediction generated by the ML model in response to receiving various data inputs, including one or more of the first dispute information, the second dispute information, and/or the amount in controversy. In some aspects, the predicted optimal settlement amount may change, for example, as measure of emotional settlement of one or more of the users changes, or as other changes in input data occur (e.g., changes in available evidence).

FIG. 4 illustrates an example graphical user interface (GUI) display 400 that can be used to to convey information generated by a settlement-prediction ML model. In particular, display 400 illustrates an example communication 400 that can be automatically generated and provided to one or more users of the mediation platform. The graphic of display 400 provides an indication of an optimal settlement amount (e.g., $740) that has the highest likelihood of being accepted for settlement by all disputant parties (e.g., 82% probability). Display 400 also provides other settlement suggestions and their associated probabilities, for example, an amount of $864 has a 51% of being accepted, whereas an amount of $987 has a 35% acceptance probability. Additionally, display 400 is configured to accept user inputs, such as by receiving a user selection of one of the recommended settlement amounts, or by receiving a user inputted settlement offer.

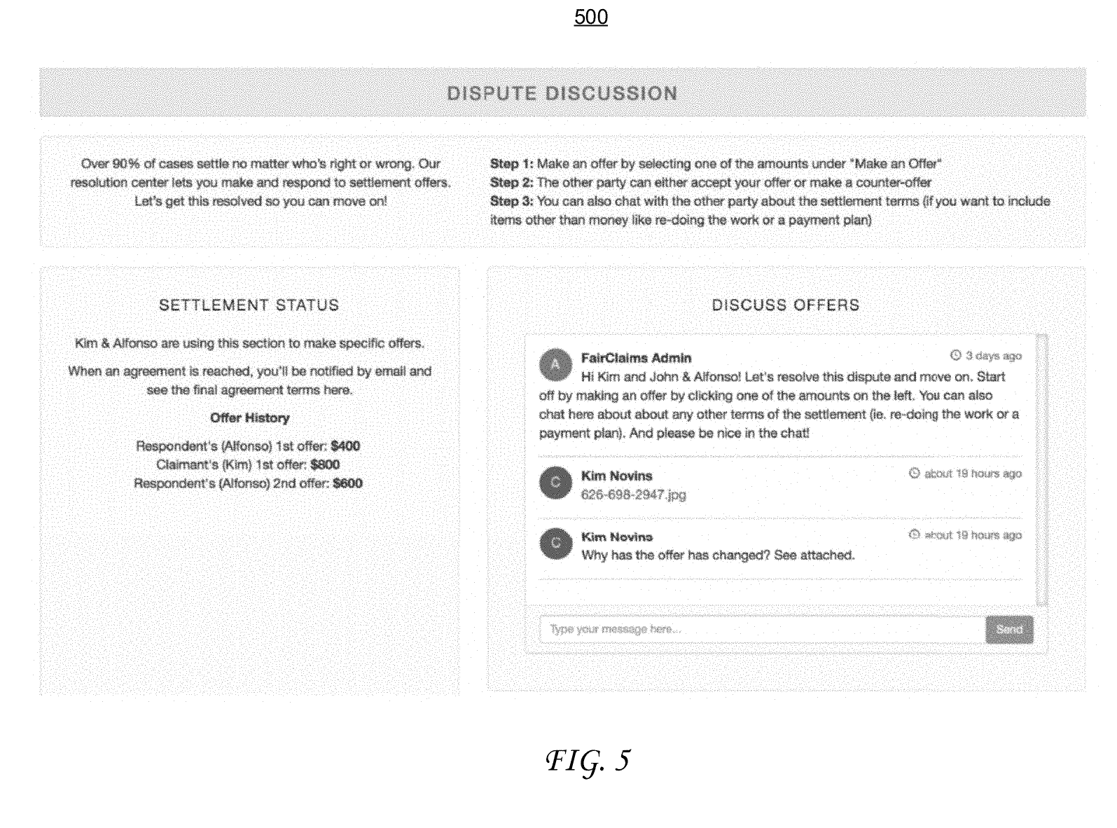

FIG. 5 illustrates an example GUI display 500 that can be provided to a user to convey information generated by a settlement-facilitation AI chat bot (settlement-facilitation ML model). Specifically, display 500 provides instructions for use of the platform, as well as communications pertaining to the settlement status of the dispute, i.e., a history of offers made, etc. Display 500 can also display messages automatically generated by the mediation platform's AI chat bot, such as, that provided by “FairClaims Admin”, encouraging the disputants to reach a settlement agreement.

By providing a mediation platform that includes the ability to perform settlement predictions, using a settlement prediction ML, and to automatically generate user communications, using an AI chat bot, the disclosed mediation platform automates the most critical aspects of dispute mediation. Additionally, through the use of ML models that can be continuously trained using new settlement and demographic data, the disclosed systems continuously improve in accuracy an applicability to various dispute types.

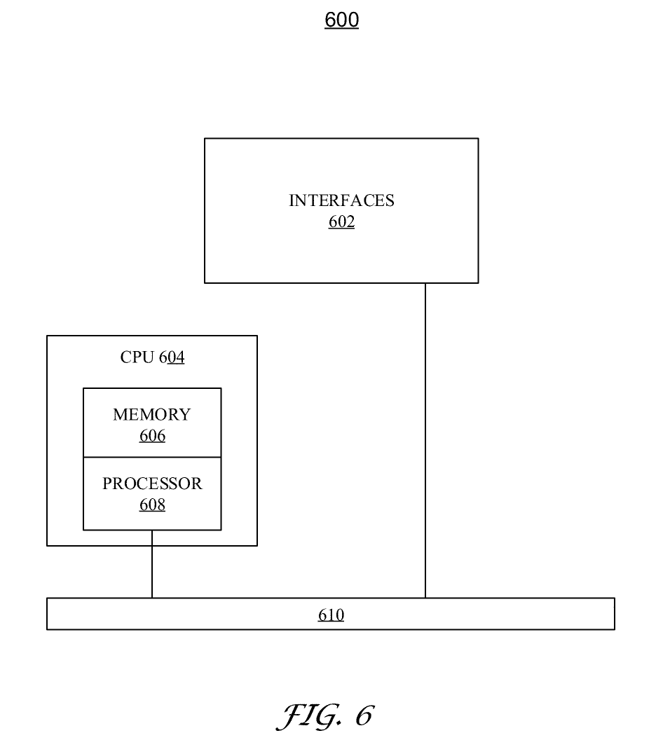

FIG. 6 illustrates an example processor-based device 600 suitable for implementing a mediation platform of the subject technology. Processor-based device 600 includes a central processing unit (CPU) 604, interfaces 602, and a bus 610 (e.g., a PCI bus). When acting under the control of appropriate software or firmware, CPU 604 is responsible for executing packet management, error detection, and/or routing functions. CPU 604 accomplishes all these functions under the control of software including an operating system and any appropriate applications software. CPU 604 can include one or more processors 608, such as a processor from the INTEL X86 family. In some cases, processor 608 can be specially designed hardware for controlling the operations of processor-based device 600. In some cases, memory 606 (e.g., non-volatile RAM, ROM, etc.) also forms part of CPU 604. However, there are many different ways in which memory could be coupled to the system.

Interfaces 602 are typically provided as modular interface cards (sometimes referred to as “line cards”). They can control the sending and receiving of data packets over the network and sometimes support other peripherals used with the processor-based device 600. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master microprocessor 604 to efficiently perform routing computations, network diagnostics, security functions, etc.

Although the system shown in FIG. 6 is one specific network device of the present invention, it is by no means the only network device architecture on which the present invention can be implemented. For example, an architecture having a single processor that handles communications as well as routing computations, etc., is often used. Further, other types of interfaces and media could also be used with processor-based device 600.

Regardless of the network device's configuration, it may employ one or more memories or memory modules (including memory 606) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 406 could also hold various software containers and virtualized execution environments and data.

Processor-based device 600 can also include an application-specific integrated circuit (ASIC). The ASIC can communicate with other components in the network device 600 via the bus 610, to exchange data and signals and coordinate various types of operations by the network device 600, such as routing, switching, and/or data storage operations, for example.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A computer-implemented method for facilitating dispute resolution, comprising:
receiving first dispute information associated with a first user, wherein the first dispute information comprises first demographic information for the first user;
receiving second dispute information associated with a second user, wherein the second dispute information comprises second demographic information for the second user;
identifying an amount in controversy from the first dispute information and the second dispute information; and
predicting an optimal settlement amount based on the first dispute information, the second dispute information, and the amount in controversy.

2. The computer-implemented method of claim 1, wherein predicting the optimal settlement amount further comprises:
providing at least one of: the first dispute information, the second dispute information or the amount in controversy, to a settlement-prediction machine-learning (ML) model; and
receiving the optimal settlement amount from the settlement prediction ML model, wherein the optimal settlement amount corresponds with a value most likely to be accepted by the first user and the second user in a settlement agreement.

3. The computer-implemented method of claim 1, further comprising:
generating one or more settlement suggestions based on the optimal settlement amount, wherein each of the settlement suggestions is associated with a predicted likelihood of acceptance; and
automatically providing the one or more settlement suggestions to the first user and the second user.

4. The computer-implemented method of claim 1, wherein the first dispute information and the second dispute information comprises a dispute location indicating a geographic region or legal jurisdiction of a dispute between the first user and the second user.

5. The computer-implemented method of claim 1, wherein the first dispute information and the second dispute information comprises a dispute type indicating a type of dispute between the first user and the second user.

6. The computer-implemented method of claim 1, further comprising:
receiving a message from the first user, wherein the message comprises a text input provided by the first user; and
analyzing the message from the first user to determine a sentiment associated with the first user, and wherein predicting the optimal settlement amount is further based on the sentiment associated with the first user.

7. The computer-implemented method of claim 1, further comprising:
sending a deadline notification to the first user and the second user, wherein the deadline notification provides a reminder regarding a settlement deadline for the dispute between the first user and the second user.

8. A system for facilitating dispute resolution, comprising:
one or more processors; and
a computer-readable medium comprising instructions stored therein, which when executed by the processors, cause the processors to perform operations comprising:
receiving first dispute information associated with a first user, wherein the first dispute information comprises first demographic information for the first user;
receiving second dispute information associated with a second user, wherein the second dispute information comprises second demographic information for the second user;
identifying an amount in controversy from the first dispute information and the second dispute information; and
predicting an optimal settlement amount based on the first dispute information, the second dispute information, and the amount in controversy.

9. The system of claim 8, wherein predicting the optimal settlement amount further comprises:
providing at least one of: the first dispute information, the second dispute information or the amount in controversy, to a settlement-prediction machine-learning (ML) model; and
receiving the optimal settlement amount from the settlement prediction ML model, wherein the optimal settlement amount corresponds with a value most likely to be accepted by the first user and the second user in a settlement agreement.

10. The system of claim 8, wherein the processors are further configured to perform operations comprising:
generating one or more settlement suggestions based on the optimal settlement amount, wherein each of the settlement suggestions is associated with a predicted likelihood of acceptance; and
automatically providing the one or more settlement suggestions to the first user and the second user.

11. The system of claim 8, wherein the first dispute information and the second dispute information comprises a dispute location indicating a geographic region or legal jurisdiction of a dispute between the first user and the second user.

12. The system of claim 8, wherein the first dispute information and the second dispute information comprises a dispute type indicating a type of dispute between the first user and the second user.

13. The system of claim 8, wherein the processors are further configured to perform operations comprising:
receiving a message from the first user, wherein the message comprises a text input provided by the first user; and
analyzing the message from the first user to determine a sentiment associated with the first user, and wherein predicting the optimal settlement amount is further based on the sentiment associated with the first user.

14. The system of claim 8, wherein the processors are further configured to perform operations comprising:
sending a deadline notification to the first user and the second user, wherein the deadline notification provides a reminder regarding a settlement deadline for the dispute between the first user and the second user.

15. A non-transitory computer-readable storage medium comprising instructions stored therein, which when executed by one or more processors, cause the processors to perform operations comprising:
receiving first dispute information associated with a first user, wherein the first dispute information comprises first demographic information for the first user;
receiving second dispute information associated with a second user, wherein the second dispute information comprises second demographic information for the second user;
identifying an amount in controversy from the first dispute information and the second dispute information; and
predicting an optimal settlement amount based on the first dispute information, the second dispute information, and the amount in controversy.

16. The non-transitory computer-readable storage medium of claim 15, wherein predicting the optimal settlement amount further comprises:
providing at least one of: the first dispute information, the second dispute information or the amount in controversy, to a settlement-prediction machine-learning (ML) model; and
receiving the optimal settlement amount from the settlement prediction ML model, wherein the optimal settlement amount corresponds with a value most likely to be accepted by the first user and the second user in a settlement agreement.

17. The non-transitory computer-readable storage medium of claim 15, wherein the instructions are further configured to cause the processors to perform operations comprising:
generating one or more settlement suggestions based on the optimal settlement amount, wherein each of the settlement suggestions is associated with a predicted likelihood of acceptance; and
automatically providing the one or more settlement suggestions to the first user and the second user.

18. The non-transitory computer-readable storage medium of claim 15, wherein the first dispute information and the second dispute information comprises a dispute location indicating a geographic region or legal jurisdiction of a dispute between the first user and the second user.

19. The non-transitory computer-readable storage medium of claim 15, wherein the first dispute information and the second dispute information comprises a dispute type indicating a type of dispute between the first user and the second user.

20. The non-transitory computer-readable storage medium of claim 15, wherein the instructions are further configured to cause the processors to perform operations comprising:
receiving a message from the first user, wherein the message comprises a text input provided by the first user; and
analyzing the message from the first user to determine a sentiment associated with the first user, and wherein predicting the optimal settlement amount is further based on the sentiment associated with the first user.
